(19) United States
(12) Patent Application Publication
(10) Pub. No.: US 2024/0353811 A1
(43) Pub. Date: Oct. 24, 2024

(54) METHOD FOR OPERATING A MACHINE TOOL AND/OR PRODUCTION MACHINE

(71) Applicant: Siemens Aktiengesellschaft, 80333 München (DE)

(72) Inventors: JOCHEN BRETSCHNEIDER, Owingen (DE); ELMAR SCHÄFERS, Fürth (DE); GERHARD SPORER, Lauf (DE)

(73) Assignee: Siemens Aktiengesellschaft, 80333 München (DE)

(21) Appl. No.: 18/687,711

(22) PCT Filed: Aug. 19, 2022
(86) PCT No.: PCT/EP2022/073176

§ 371 Date: Feb. 28, 2024

(30) Foreign Application Priority Data
Sep. 30, 2021 (EP) 21200044.2

(51) Int. Cl. G05B 19/404; B23Q 15/12

(52) U.S. Cl. CPC G05B 19/404; B23Q 15/12; G05B 2219/42066

(57) ABSTRACT

A method for operating a machine tool and/or production machine comprising comparing at least one target position, speed, and/or acceleration value of a machine shaft and/or of a tool center point with an actual position, speed, and/or acceleration value. At least one actual quality value is formed on the basis of the comparison or comparisons. A target quality value is compared with the actual quality value. A feed speed and/or acceleration and/or jerk of the machine shaft and/or of the tool center point is reduced if a defined deviation of the actual quality value from the target quality value is exceeded, or storing information that the defined deviation of the actual quality value from the target quality value has been exceeded if the defined deviation of the actual quality value from the quality target value is exceeded.

The invention relates to a method for operating a machine tool and/or production machine.

Machine tools and/or production machines are designed to machine workpieces. Components can be created for different areas.

Precise or fine machining is, for example, necessary in tool and mold making. For example, precise shapes are important in the production of molds for PET bottles or Lego bricks.

Furthermore, high manufacturing accuracy is, for example, required for optical components such as spectacle lenses, components of lenses or eyepieces and components for telescope mirrors, cameras and microscopes.

Likewise, high manufacturing accuracy is also required in other machining technologies, such as, for example, turning of pump pistons, synchronizer gears, injection nozzles or bearing bushes.

Fine machining is aimed at very high machining accuracy and very high-quality surface finish on the component or workpiece.

Examples of fine machining are, for example, a finishing process during milling in tool and mold making or fine or ultra-fine finishing or also fine or precision turning of turned parts.

Finishing is often carried out after roughing with the aim of achieving the required surface finish quality as well as dimensional and shape accuracy. In connection with the accuracy requirements for the workpiece, experts are familiar with the terms finishing, fine finishing or ultra-fine finishing.

Finishing is generally used for end or final machining, but a subsequent manufacturing step, such as, for example, polishing, may also be required. Improvements are made, for example, by reducing the process forces and by using high-precision machines and tools. However, this is very cost-intensive.

Any unwanted vibrations that occur at a machining point between the tool and workpiece have a negative impact on quality and surface finish. This results in the need for complex and expensive manual re-machining, for example polishing. This leads to increased costs and throughput time.

US 2019/126474 A1 describes a method and an apparatus for a computer-aided motion engine that iteratively computes a numerical “jerk”, the motion derivative of acceleration, using real-time feedback from a system under motion control, to reach both a desired position and desired velocity of a next waypoint. The output from the motion engine is only the desired acceleration, which is then passed to a motor driver, free of intermediate computations of either position or velocity. A second inside feedback loop maintains the desired acceleration or torque at the motor axis based on the acceleration output of the motion engine, which may use non-linear correction tables. Waypoints comprising both position and velocity are inputs to the motion engine. Time to the next waypoint is computed rather than provided as an input. Optimization of moves to the next waypoint is based on the smoothest velocity change during the move. Embodiments include mechanical two axis SCARA arm motion systems.

EP 3470943 A2 describes a method for calculating reference variables for interpolating moving single axes of a precision machine based on a given 3D tool path firstly for all points of the tool path offline assuming a freely selected path velocity or single-axis velocity, the velocity, acceleration and jerk profiles of all the interpolating axes are calculated cohesively and without specifying limiting values and then velocity, acceleration or jerk profiles are varied on regions on the 3D tool path.

The invention is based on the object of achieving high surface finish quality with high productivity.

The object is achieved by claim 1, i.e., a method for operating a machine tool and/or production machine with the following steps:
comparing at least one target position value of a machine axis and/or a tool center point with an actual position value and/or
comparing at least one target speed of the machine axis and/or the tool center point with an actual speed and/or
comparing at least one target acceleration of the machine axis and/or the tool center point with an actual acceleration,
forming at least one actual quality value on the basis of the comparison or comparisons, wherein a difference signal is ascertained from the target position values and the actual position values and/or from the target speeds and the actual speeds and/or from the target accelerations and the actual accelerations over a specific period of time and the difference signal is fed to a signal analysis method,
comparing a target quality value with the actual quality value,
reducing a feed speed and/or acceleration and/or jerk of the machine axis and/or the tool center point if a defined deviation of the actual quality value from the target quality value is exceeded or storing information about the fact that the defined deviation of the actual quality value from the target quality value has been exceeded if the defined deviation of the actual quality value from the target quality value is exceeded.

This enables fine machining to be ensured in real time or high accuracy to be achieved through area-precise or pinpoint re-machining, since information on this is available.

The method advantageously has the following further step:
increasing a feed speed and/or acceleration and/or jerk of the tool center point if the defined deviation or a further defined deviation of the actual quality value from the target quality value is fallen below.

In other words, this advantageously means: if the defined deviation is exceeded, the described reduction takes place. This improves accuracy. This is accompanied by an improvement or equalization of the actual quality value in the direction of the target quality value. If the defined deviation or further defined deviation is fallen below, the described increase takes place.

Here, preferably, the further defined deviation is the decisive factor for the increase in order to avoid a constantly alternating reduction and increase in the feed speed and/or acceleration and/or jerk.

In one advantageous embodiment, the target quality value and/or the defined deviation and/or the further defined deviation are stored in a parts program and/or entered into a control system of the machine tool and/or production machine, in particular a numerical control system.

The values can therefore be entered in advance as well as directly during operation, in particular by a user on the machine.

Here, storage in the control system cannot, for example, usually be changed by the user, here, storage in the parts program allows changes to be made during operation.

In one advantageous embodiment, the actual position value and/or the actual speed and/or the actual acceleration are captured by means of at least one measuring system.

Possible measuring systems are explained further below.

In one advantageous embodiment, a measuring frequency of the actual position value and/or the actual speed and/or the actual acceleration is at least 500/s. at most 1500/s, preferably at least 800/s and at most 1200/s, in particular 1000/s.

This achieves a sufficiently good and accurate measurement.

In one advantageous embodiment, the actual position value is captured by a rotary transducer arranged in or on the machine tool and/or production machine and/or a linear scale arranged in or on the machine tool and/or production machine.

Preferably, the actual position value is captured using a glass scale or another length measuring device. Other optical measuring systems are also conceivable.

The linear scale, in particular the glass scale, is usually arranged at a certain distance from the tool center point (TCP).

In one advantageous embodiment, the actual speed and/or the actual acceleration is captured by at least one sensor, wherein the sensor is arranged on or close to the tool center point or on or close to a workpiece, which is machined by the machine tool and/or production machine.

Preferably, the sensor for measuring the actual acceleration is an accelerometer. This advantageously measures the acceleration in at least one or three spatial directions.

The sensor for measuring the actual acceleration is advantageously arranged in the vicinity of the TCP, for example in the vicinity of a milling head.

The sensor for measuring the actual speed is advantageously arranged in the vicinity of the TCP.

Alternatively, it is possible to calculate the actual speed at the TCP from the actual position value and actual acceleration.

Advantageously, the measurement is performed where vibration occurs, or least in the vicinity thereof. Vibration that is to be avoided or reduced by the method described can occur on the TCP side as well as on the workpiece side.

The object is also achieved by a machine tool and/or production machine for performing the method.

Preferably, the machine tool and/or production machine has a control system, in particular a numerical control system, or is connected to a control system, in particular a numerical control system.

The object is also achieved by a control system for a machine tool and/or production machine.

The object is furthermore achieved by a computer program product comprising instructions, which, when the program is executed by the control system, cause it to execute the method.

The invention offers the advantage that the finishing process does not require the jerk and possibly the acceleration of the axes of the machine tool involved in the finishing process to be permanently reduced in order to achieve reduced excitation of mechanical vibrations of the machine tool and/or production machine. Dynamic action is possible. This shortens the machining time of a workpiece on the machine tool and/or production machine. As a result, costs are reduced and throughput time is shortened.

The invention is described and explained in more detail below with reference to the exemplary embodiments shown in the figures.

It is shown in:

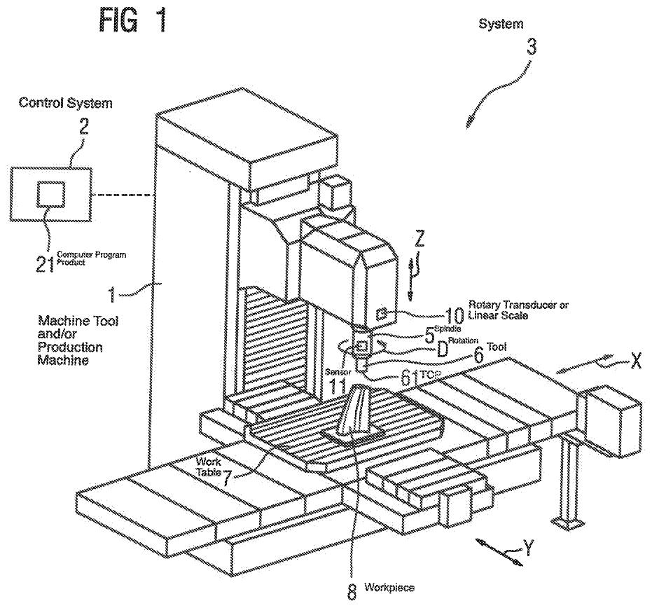

FIG. 1 a system having a machine tool and/or production machine and a control system,

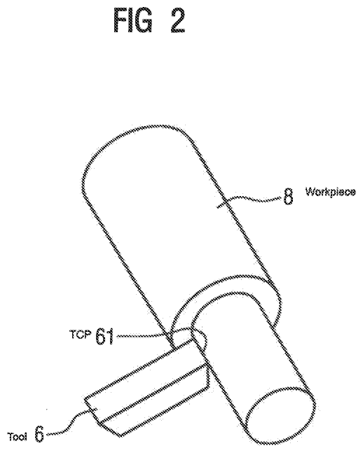

FIG. 2 machining of a workpiece,

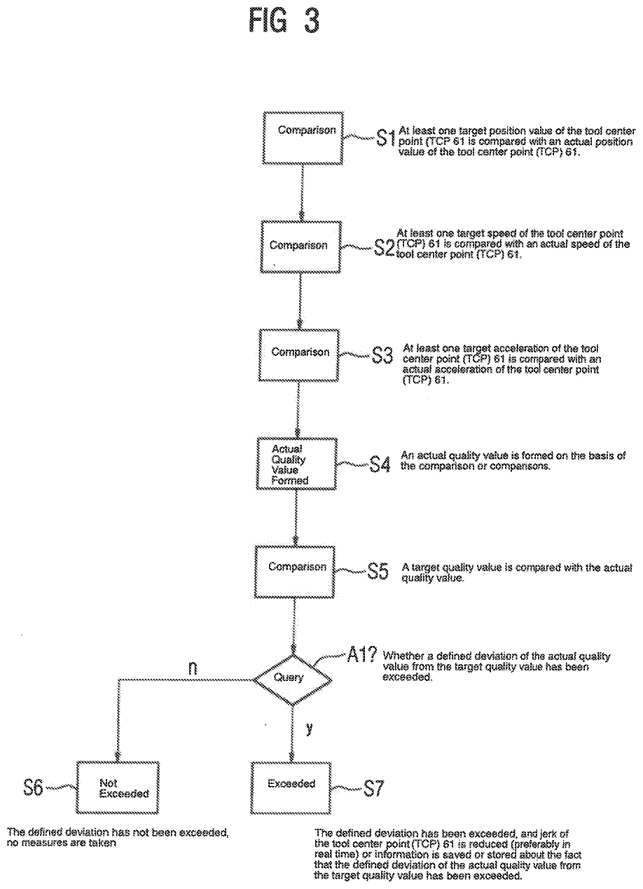

FIG. 3 method steps,

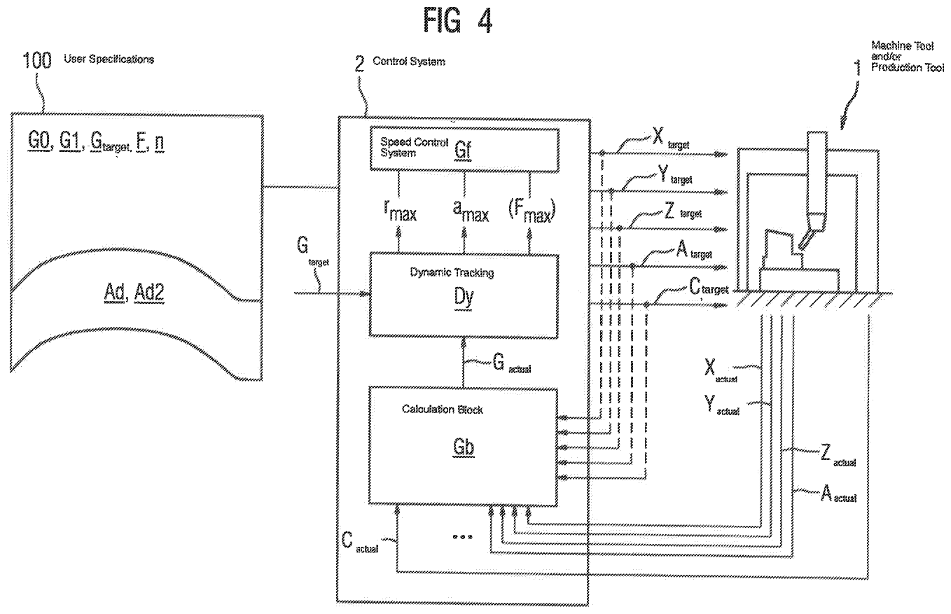

FIG. 4 an exemplary embodiment of the method,

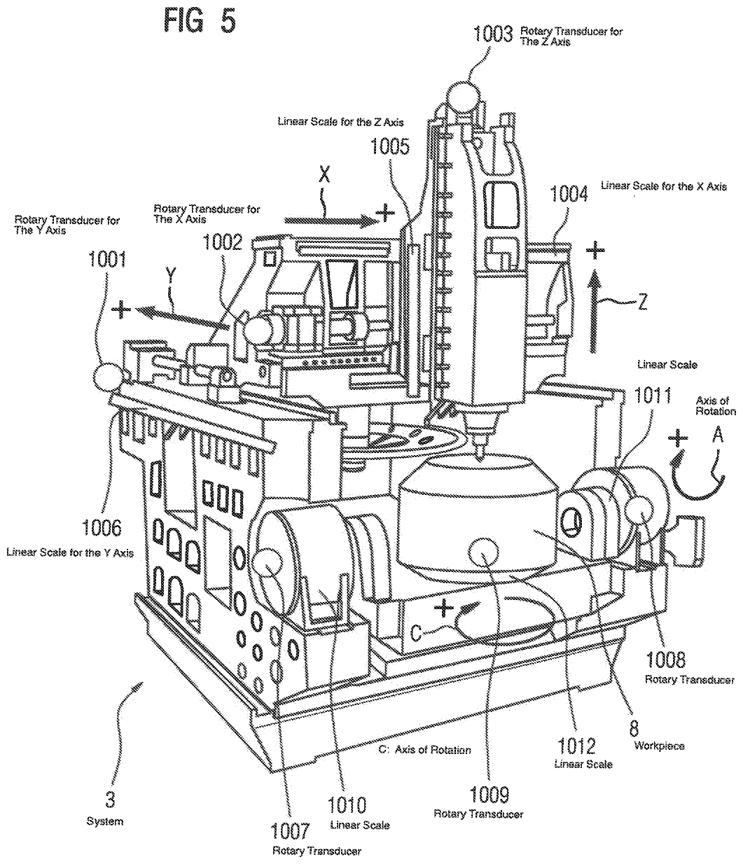

FIG. 5 a further possible machine tool and/or production machine,

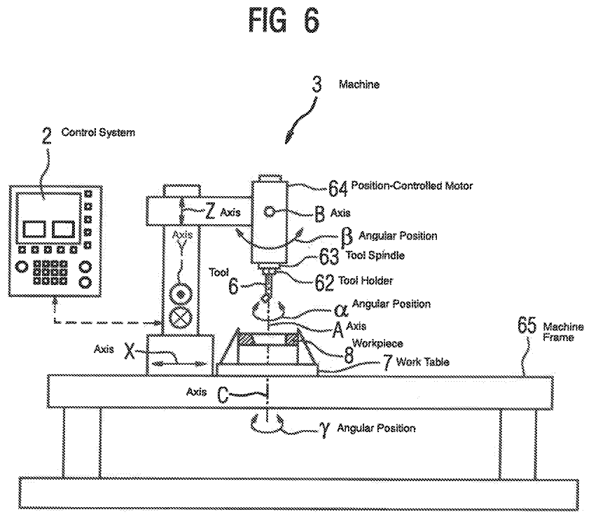

FIG. 6 a further possible machine tool and/or production machine.

FIG. 1 shows a machine tool and/or production machine 1 and a control system 2. They form a system 3. In the figure, the machine tool and/or production machine 1 comprises a spindle 5 to which a tool 6 (in the figure for milling) is attached.

A spindle rotation (and hence a rotation of the milling tool) is marked D in the figure.

A tool tip or an engagement point of the tool 6 is advantageously described by a tool center point 61 (TCP). In the figure, the tool center point 61 is located at a tool tip.

In the figure, a workpiece 8 is located on a work table 7. The tool 6 is advantageously used to machine the workpiece 8.

The figure shows a means for capturing an actual position value 10 of the TCP 61, for example in the form of a rotary transducer or linear scale.

In this figure, the arrangement of the means for capturing the actual position value 10 is shown purely by way of example. Reference is made to the explanations for FIG. 5.

In the figure, an actual speed and/or an actual acceleration of the TCP 61 is captured by a sensor 11. In the figure, the sensor 11 is arranged on or close to the tool center point 61. The sensor 11 can also be arranged in the vicinity of the means for capturing 10.

The sensor 11 can also be arranged on or close to the workpiece 8, which is machined by the machine tool and/or production machine 1.

In the figure, the control system 2, which is in particular embodied as a numerical control system, has a computer program product 21. The computer program product 21 comprises instructions, which, when the program is executed by the control system 2, cause the control system 2 to execute the method described in FIG. 4.

For this purpose, the computer program product 21 is advantageously stored in the control system.

FIG. 2 shows the machining of the workpiece 8, in particular milling.

In the figure, the tool 6 removes material. The TCP 61 is arranged on the tip of the tool.

The invention is well suited for methods in which material is removed. Other applications are also possible.

FIG. 3 shows method steps of the method for operating a machine tool and/or production machine.

In method step S1, at least one target position value of the tool center point 61 is compared with an actual position value of the tool center point 61.

The target position value is advantageously specified and stored or available in the control system 2. The target position value can also be calculated by the control system. The actual position value is advantageously measured, in particular by the means for capturing an actual position value 10.

In method step S2, at least one target speed of the tool center point 61 is compared with an actual speed of the tool center point 61.

Advantageously, the target speed is specified and stored in the control system 2. The actual speed is advantageously captured by means of the sensor 11.

In method step S3, at least one target acceleration of the tool center point 61 is compared with an actual acceleration of the tool center point 61.

Advantageously, the target acceleration is specified and stored in the control system 2. The actual acceleration is advantageously captured by means of the sensor 11.

It is possible for method steps S1, S2 and S3 to be performed one after the other. Another sequence of method steps is also possible.

Furthermore, it is also possible for only one or two of the aforementioned method steps to be performed.

In method step S4, an actual quality value is formed on the basis of the comparison or comparisons.

Advantageously, the actual quality value is a number. Advantageously the target quality value is a number.

In method step S5, a target quality value is compared with the actual quality value.

Advantageously, the target quality value has already been defined beforehand. Advantageously, the target quality value is stored in the control system.

The target quality value is advantageously dependent on an intended accuracy.

In A1, a query is made as to whether a defined deviation of the actual quality value from the target quality value has been exceeded.

Advantageously, the defined deviation has already been defined beforehand. Advantageously, the defined deviation is stored in the control system.

The defined deviation and also a further defined deviation are advantageously a number.

If the defined deviation has not been exceeded, marked by n, no measures are taken in method step S6.

If the defined deviation has been exceeded, marked by j, in method step S7, either the feed speed and/or acceleration and/or jerk of the tool center point 61 is reduced (preferably in real time) or information is saved or stored about the fact that the defined deviation of the actual quality value from the target quality value has been exceeded.

The information is advantageous since it makes it known, for example, that re-machining is required on one or more points of the workpiece 8.

If the value is fallen below, the feed speed, acceleration and/or jerk are increased, as already explained above.

FIG. 4 shows an exemplary embodiment of the method. The figure shows a tracking method for achieving a machining quality specified by the user.

In the figure, user specifications 100 are specifications for the path G0, G1, feed F, spindle feed n and target quality number, typically in the form of a parts program. Furthermore, the defined deviation Ad and advantageously a further defined deviation Ad2 are also specified.

The control system 2 advantageously analyzes the deviation between specified target position values Xtarget, Ytarget, Ztarget, Atarget and Ctarget (target values for the five axes) and actual position values Xactual, Yactual, Zactual, Aactual and Cactual (actual values of the five axes) measured on the measuring system in relation to both the axes and the path.

A comparison of target speed with actual speed or target acceleration with actual acceleration is performed similarly to the method depicted based on the comparison of target position values with actual position values.

This analysis can also comprise a deviation between commanded and measured speed or acceleration.

For this purpose, advantageously, the rotary transducers or linear scales installed in the machine are used to capture target position values and additional sensors arranged close to the TCP (tool side) or the workpiece (tool side) are used to measure the speed or the acceleration.

The control system 2 uses the analysis of specified target and actual values as the basis for forming a parameter for determining the quality of fine machining. This is the actual quality value Gactual. To determine the actual quality value Gactual, signal processing of the target and actual values is performed in the time and/or frequency domain. This takes place in the quality calculation block Gb.

Using the example of position values, here, a difference signal between target position values and actual position values is advantageously ascertained over a specific period of time, for example, 1 second. The difference signal is advantageously fed to standard signal analysis methods. These are, for example, based on known methods for averaging, calculating a standard deviation and/or frequency analysis.

Here, the standard deviation of the difference signal can, for example, act as a measure for the actual quality value Gactual. However, in addition to the standard deviation, other variables from the signal analysis can also be included (see above).

Likewise, in addition to the difference signal from the target position values and actual target values, alternatively or additionally, difference signals from the target speed and actual speed or target acceleration and actual acceleration can also be analyzed and included accordingly in the actual quality value in the aforementioned signal analysis.

The described signal analysis is advantageously performed analogously for further axes, preferably all axes, and advantageously for the TCP, and is advantageously included in the actual quality value, for example by means of weighting.

In the figure, the user specifies a target variable for the quality number. This is the target quality value Gtarget. Gtarget can either be programed in the parts program or entered via the control system 2.

Different materials require different target quality values in order to achieve good machining. The target quality value is advantageously a value based on experience (in particular by analyzing workpiece surfaces) from previous similar machining operations.

For example, the target quality value Gtarget can be determined by considering a plurality of workpiece surfaces, wherein an actual quality value present during machining has been determined in accordance with the above-described method, and is hence known, and the workpiece surfaces of the workpieces under consideration have been found to be of good quality.

The target quality value Gtarget can be defined in this manner.

In the method shown, to set the actual quality value Gactual to the target quality value Gtarget (see dynamic tracking Dy), the control system 2 modifies the dynamic parameters jerk rmax and acceleration amax of the control system 2. Here, in the dynamic tracking Dy, a check is performed as to whether the defined deviation Ad is exceeded. It is also possible to check whether the defined deviation has been fallen below or whether the further defined deviation has been fallen below.

As a result, the method advantageously continuously tracks key parameters of a speed control system Gf of the control system 2.

However, instead of continuous tracking it is also possible to switch to another parameter set of the dynamic parameters. This enables the required surface finish quality to be achieved.

If it is possible for the control system 2 to ascertain the maximum possible feed by evaluating cutting parameters, in addition to the modification of jerk rmax and acceleration amax, it is also possible to modify the feed Fmax with the aim of achieving maximum productivity with a specified quality.

Increasing rmax and amax as well as Fmax if the defined deviation Ad or the further defined deviation Ad2 of the actual quality value from the target quality value is fallen below is advantageous for shortening throughput time.

The invention offers the advantage that machining situations that would lead to reduced machining quality are recognized within the control system. This can be advantageously rectified immediately by the described method. Alternatively, information about this can be stored so that re-machining can take place.

However, it is advantageous to react promptly in order to ensure processing quality by modifying the dynamic parameters.

An algorithm integrated into the control system that increases the dynamics and also the (feed) speed, provided that the quality criterion is met and a tool permits this, is likewise advantageous.

FIG. 5 shows a suitable arrangement of means for capturing target position values.

For this purpose, the figure shows a rotary transducer for the Y axis 1001, a rotary transducer for the X axis 1002 and a rotatory transducer for the Z axis 1003.

Preferably, a linear scale for the X axis 1004 is arranged on and close to the point shown. Preferably, a linear scale for the Z axis 1005 is arranged on and close to the point shown. Preferably, a linear scale for the Y axis 1006 is arranged on and close to the point shown.

The figure also shows the axes of rotation A and C. These enable the workpiece to be tilted (for example by means of a rotary swivel table).

This tilting can also be captured by linear scales 1010, 1011, 1012 or also by rotary transducers 1007 or alternatively or additionally 1008 (A axis) and 1009 (C axis).

FIG. 6 shows a further possible machine tool and/or production machine 3 for which the invention is suitable.

In the context of this exemplary embodiment, the machine tool and/or production machine 3 has six machine axes X, Y, Z, A, B, C, by means of which a relative movement can be performed between the tool 6, which in this exemplary embodiment takes the form of a turning tool, and a workpiece 8. In this figure, the tool 6 is clamped in a tool holder 62 that is connected to a tool spindle 63, which in this exemplary embodiment is driven by a position-controlled motor 64.

The tool 6 can advantageously be moved in a translatory manner along the X, Y and Z axes.

The figure also shows rotary axes A and B with which the tool 6 can be rotated about the respective axis and likewise aligned in a position-controlled manner relative to the workpiece 8 through the angular positions α and β.

Moreover, in this exemplary embodiment, the machine 3 has a third position-controlled rotary axis C that runs parallel to the Z axis and in relation to which the work table 7 is rotatably mounted relative to a stationary machine frame 65. This also enables the workpiece 8 to be positioned in an angular position γ relative to the tool 1.

1.-11. (canceled)

12. A method for operating a machine tool and/or production machine comprising:
comparing at least one target position value of a machine axis and/or a tool center point with an actual position value; and/or
comparing at least one target speed of the machine axis and/or the tool center point with an actual speed; and/or
comparing at least one target acceleration of the machine axis and/or the tool center point with an actual acceleration;
forming at least one actual quality value based on the comparison or comparisons;
ascertaining a difference signal from the target position values and the actual position values and/or from the target speeds and the actual speeds and/or from the target accelerations and the actual accelerations over a specific period of time;
feeding the difference signal to a signal analysis method, wherein variables determined using the signal analysis are included in the actual quality value;
comparing a target quality value with the actual quality value; and
reducing a feed speed and/or acceleration and/or jerk of the machine axis and/or the tool center point when a defined deviation of the actual quality value from the target quality value is exceeded or storing information about the defined deviation of the actual quality value from the target quality value has been exceeded when the defined deviation of the actual quality value from the target quality value is exceeded.

13. The method of claim 12 further comprising increasing a feed speed and/or acceleration and/or jerk of the machine axis and/or the tool center point when the target quality value falls below the defined deviation or a further defined deviation of the actual quality value.

14. The method of the claim 12, wherein the target quality value and/or the defined deviation and/or the or a further defined deviation are stored in a parts program and/or are entered into a control system of the machine tool and/or production machine, in particular a numerical control system.

15. The method of claim 12, wherein the actual position value and/or the actual speed and/or the actual acceleration are captured by at least one measuring system.

16. The method of claim 12, wherein a measuring frequency of the actual position value and/or the actual speed and/or the actual acceleration is at least 500/s, at most 1500/s, preferably at least 800/s and at most 1200/s, in particular 1000/s.

17. The method of claim 12, wherein the actual position value is captured by a rotary transducer arranged in or on the machine tool and/or production machine and/or a linear scale arranged in or on the machine tool and/or production machine.

18. The method of claim 12, wherein the actual speed and/or the actual acceleration is captured by at least one sensor, wherein the sensor is arranged on or close to the tool center point or on or close to a workpiece, which is machined by the machine tool and/or production machine.

19. A machine tool and/or production machine for performing a method as set forth in claim 12.

20. The machine tool and/or production machine of claim 19, comprising a control system or connected to a control system, in particular a numerical control system.

21. A control system for a machine tool and/or production machine as set forth in claim 19.

22. A computer program product comprising instructions, which, when the program is executed by the control system of claim 21, cause it to execute a method as set forth in claim 12.
